(19) United States
(12) Patent Application Publication
(10) Pub. No.: US 2025/0332935 A1
(43) Pub. Date: Oct. 30, 2025

(54) DEVICE FOR REDUCING THE FORCE NEEDED FOR AUTOMATICALLY INSERTING/EXTRACTING A CONNECTOR ATTACHED TO AN ELECTRIC VEHICLE CHARGER INTO AN ELECTRIC VEHICLE SOCKET

(71) Applicant: Rocsys B.V., Rijswijk (NL)

(72) Inventor: Johannes Oosten van der Weijde, Delft (NL)

(21) Appl. No.: 18/867,343

(22) PCT Filed: May 15, 2023
(86) PCT No.: PCT/EP2023/063018

§ 371 Date: Nov. 19, 2024

(30) Foreign Application Priority Data
May 27, 2022 (NL) 2032011

(51) Int. Cl. B60L 53/16; B60L 53/37; H01R 13/04; H01R 13/10; H01R 13/629

(52) U.S. Cl. CPC B60L 53/16; B60L 53/37; H01R 13/04; H01R 13/10; H01R 13/629

(57) ABSTRACT

A device for connecting an EV charger connector to or disconnecting it from an EV socket with a supposed position and orientation. A connector handling mechanism comprises an actuated positioning mechanism, for moving the connector with at least 2 degrees of freedom with respect to a fixed world of at least one compliance assembly, compliantly moving the connector in at least two degrees of freedom with respect to the fixed world, wherein the at least one compliance assembly is connected kinematically in series with the positioning mechanism, between the fixed world and the connector; and has a compliance stroke defined as the effective displacement between an actual connector position and orientation, and a current/momentary virtual position and orientation of the connector. A first moment and/or force is applied to the connector in a movement direction. A second moment and/or force is superimposed on the first moment and/or force.

### BACKGROUND OF THE INVENTION

The present invention relates to a device for reducing the force needed for automatically inserting/extracting a connector attached to an electric vehicle charger, respectively into or out of an electric vehicle socket. The terms inserting and extracting may throughout this application be replaced with respectively connecting and disconnecting, or with respectively plugging in and plugging out.

Automatically inserting or extracting electric charging connectors in electric vehicle sockets has become a new goal for large fleet owners during recent years. Many electric vehicles have vehicle sockets meant for manually plugging in, such as vehicle sockets according to IEC 62196. The combination of connector and vehicle socket typically has a tightly fitting geometry. Hence, plugging it in automatically requires a certain degree of accuracy in positioning, orientating, and inserting or extracting the connector. The combination will always experience friction while inserting or extracting, where contact force between the conductors in connector and socket are the main contributor. Many factors can contribute to the friction like designed and manufacturing tolerances, weather conditions, wear and tear, and other designed characteristics of the connector and socket. Another major contributor may be a misalignment between connector and socket while inserting or extracting, for example due to past or present motion of the vehicle, misestimation of the socket position, or control inaccuracies of the automatic mechanism for insertion/extraction (f.e. a charging robot).

Such a misalignment can cause the electric vehicle charger to need a supplementary force (above specification) in order to insert or extract the connector into the electric vehicle socket, with the corresponding risk of damage to the vehicle, charging robot or unexpected objects or persons present between or around the charging robot and the electric vehicle.

Extracting a significantly misaligned connector is difficult (imagine pulling a block out of a tight hole using a string under an angle with the extraction direction). A misalignment between connector and robot can only occur when the system can facilitate a significant compliance stroke. A compliance stroke in the context of the present disclosure denotes the distance that a system or a component thereof may move in response to an external force. This may for example happen due to loading/unloading of a vehicle, when it suspension is compressed or relieved due to added weight. This may be the result of working with a dedicated device: it plugs a connector it in and holds it, while a human plugs in, and releases the connector, but may also happen when a device emulates human operation (subsequently plugging in, releasing the connector, waiting for charging to be complete, reattaching to the connector, and finally extracting the connector). All moments in the automated charging process where a mechanism holds a connector that is (partially) inserted into a vehicle's socket may experience the described problems.

### BRIEF DESCRIPTION OF THE PRIOR ART

Several solutions have been proposed in the art so far. The international patent application WO2019166234A1 discloses a method for automatically inserting or extracting a connector to a vehicle socket by using a vibration unit, which excite the charging connector to vibrate. While vibrations may help to reduce the required insertion or extraction force, it also complicates the design requirements for both the manipulator wielding the connector, and the vehicle with the socket. On both sides, the vibrations should be attenuated to avoid undesired effects. While the document does mention attenuation on the connector side, it does not mention it on the socket side. Furthermore, the document mentions a dedicated actuator on the connector side to generate the vibrations. It is undesirable to add a component to the end effector of the manipulator, i.e. adding weight, complexity and cost. Finally, vibrations do not solve significant misalignments, i.e. a clamping problem.

The Chinese patent application CN108790916A discloses an electric vehicle charging system including a square air bag that is inflated when the charging head approaches the socket, to overcome the problem of the position change due to variations in the car during charging.

The German Patent application DE102012014936A1 discloses a system to compensate the position and orientation offsets when positioning the connector.

Finally, a paper with DOI 10.1109/SSD.2015.7348200 discloses a strategy to reduce the force required for insertion. The use of an industrial robot with a 6-degree-of-freedom force sensor is described here to facilitate combined position and force control while inserting the connector. This solution may allow reduction of force but comes with a number of disadvantages. Force control requires sufficiently computational power to allow a high enough control frequency, deterministic control loops, and a fast and accurate response from motor controllers and motors. These requirements come with added weight and cost and are hard (if not impossible) to certify for use in a public environment. Furthermore, the implementation of a manipulator with using force control as opposed to significant physical compliance requires the manipulator to be continuously controlled during the whole charging process. Apart from wasting energy, a part of the system (manipulator, connector, socket) will brake if the controller stops for some reason, while the EV might still passively move due to its suspension.

### SUMMARY OF THE INVENTION

The systems according to the prior art in general have one or more of the following disadvantages. They are intended just for compensation of orientation or position offsets and do not solve potential clamping due to misalignment during extraction. They typically include extra devices (sensors or actuators) to function. They also are suitable just for insertion of a connector and they will not solve potential clamping due to misalignment during extraction. In general, they may not provide the effect that they reduce the at least average force needed to plug in a connector into a socket.

It is a goal of the present invention to propose a method and a system for reducing the force needed to insert or extract the socket attached to an electric vehicle charger into an electric vehicle socket, that takes away the disadvantages of the prior art, or at least forms a useful alternative therefore.

It is also a goal of the present invention to propose a method for controlling an autonomous charging device (ACD) for the autonomous connection of a connector/disconnection into/from a socket in an electric vehicle, the ACD comprising a connector handling mechanism comprising an actuated connector-positioning mechanism and a compliance assembly allowing for a compliant connection/disconnection of the connector by movement in a connection/disconnection direction. It is also a goal of the present invention to present a solution reliable and safe. A further goal is to reduce the force in the insertion direction for safety purposes. Yet another goal is to reduce costs, maintainability, enable less complex systems, and increase the robustness of the systems.

The invention therefore proposes a device and method according to the independent claims.

### BRIEF DESCRIPTION OF THE FIGURES

FIG. 1 shows a connector in a socket;

FIG. 2a shows a connector handling mechanism with compliance assemblies distributed in the kinematic chain;

FIG. 2b shows a connector handling mechanism with compliance assemblies near the connector;

FIG. 3a shows a connector handling mechanism with a compliance stroke resulting from insertion according to the invention;

FIG. 3b shows a connector in a socket slightly displaced with respect to normal insertion, within the tolerance allowed by the socket;

FIG. 4a shows a connector handling mechanism with a compliance stroke resulting from insertion according to the invention; and

FIG. 4b shows a connector in a socket, slightly displaced with respect to normal insertion, within the tolerance allowed by the socket.

### DETAILED DESCRIPTION OF THE INVENTION

During the inserting or extracting phase, there is physical contact between connector and socket. The physical contact results at least in friction. Friction and other effects such as clamping by pressing against intentional or unintentional features (ridges, scratches, etc.), caused by misalignment or in general, respectively requires a higher then nominal pushing or pulling force in the direction of the center line of the socket (as for example stated in a standard) to successfully complete insertion or extraction.

In other words, the tight-fitting geometry of the connector-socket combination often results in clamping or increased friction (static and dynamic). It may be a result of a misalignment between connector and socket, but may also happen without having misaligned the connector and socket. This requires the force needed for inserting or extracting the connector to increase, with the consequent risk of safety issues or damaging the socket, connector, or robot. Also there is a risk that the connection between socket and connector is not made properly or not at all.

One aspect of the invention is to apply a moment and/or force on the connector, on top of the one in the insertion or extraction direction, to generate a prying motion of the connector in the socket.

The fitting between socket and connector, and therefore the friction among them, depends on several factors. Among those is the design and fabrication of the connector and socket, f.e. manufacturing tolerances, contact pressure of the electrical contacts, geometric design to accommodate human insertion and/or extraction such as self-searching features, material characteristics (stiffness, roughness, etc.). Other factors are general wear and tear, misuse, but also exposure to weather conditions, or other conditions in which they were used (dirt or elements introduced in the socket).

Another contributor to friction is misalignment due to the motion of the car (and therefore the socket) at the moment of insertion/extraction, or an error or inaccuracy in motion control of the positioning mechanism. Vehicle motions may occur due to several reasons, such as loading/unloading, wind loads, adjusting vehicle suspension, etc. A charging station that facilitates an automated connection has to be able to cope with these slight vehicle motions, to avoid damage to either the infrastructure or the vehicle. This invention uses a device that combines an active positioning mechanism with physical compliance to solve that problem, which introduces the possibility of being misaligned.

In all the cases, socket-connector combinations are designed to be tightly fitting, therefore will experience friction while inserting or extracting the connector and might experience clamping.

In order to avoid these problems, alternating moments, and/or alternating forces in at least a direction different to the centre line of the socket direction (P) are applied to the connector, causing prying motions of the connector in the socket that lead to a reduction of friction and/or a levering-type motion. In the context of the present disclosure, the insertion/extraction direction, may also be referred to as the plug-in direction and may correspond to a direction which is essentially or substantially parallel to the direction of the centre lines of the pins and holes. In the context of the invention, the terms insertion, connection and plug-in may be utilized interchangeably. Likewise, the terms extraction, disconnection and plug-out may be utilized interchangeably.

The forces or moments applied to reduce the insertion or extraction force are not necessarily in the direction that would resolve a misalignment, as the purpose of them is not to overcome the misalignment itself directly or to overcome the misalignment itself completely, but to reduce the frictional forces that could be indirectly caused by the misalignments. Using the direction of misalignment would have the added benefit of that the misalignment would be resolved, if only momentarily.

Alternation of the moments and/or forces results in multiple prying actions. These alternating moments or forces can therefore also (intentionally or unintentionally) cause the connector to reach the most favorable orientation alignment a number of times, in that way facilitating the reduction of the needed force.

Performing a controlled quasi-static motion with the positioning mechanism simultaneous to the insertion or extraction motion, which would result in a motion of the connector in a different direction than insertion/extraction with respect to the socket when not at least partially inserted into the socket, effectively induces a, an additional, or a larger compliance stroke. The second movement may comprise at least one of a linear motion along the axis with the largest dimension, a rotational motion about the axis orthogonal to the axis with the largest dimension and the insertion/extraction direction; and/or a movement around the point where a misalignment would be solved.

The device according to the present disclosure comprises a connector handling mechanism comprising an actuated positioning mechanism, for moving the connector with at least 2 degrees of freedom with respect to a fixed world; and at least one compliance assembly, configured to allow compliantly moving the connector in at least two degrees of freedom with respect to the fixed world. The at least one compliance assembly compliance assembly may therefore be configured for facilitating proper connection under a misalignment occurring during insertion, for example due to misestimation of the socket position and/or orientation, and/or occurring after plugging in, for example due to passive vehicle motions resulting from (un)loading the vehicle during a charging session.

All this facilitates reducing the force necessary to connect and/or disconnect the connector and socket in comparison with the force required to connect the connector solely with the use of a force in the direction of the insertion/extraction. For example, this allows insertion and extraction of the connector with a force in the center of the socket direction that can be lower than without a lateral motion.

A lateral translational and/or a rotational motion will result in the compliance coming across a point of significantly less (or no) misalignment, making it easier to pull out.

Some devices that are suitable to be configured according to the present invention are described in patent applications of the same applicant, in particular numbers NL 2023019, NL2024952, NL 2025959, NL2026365, NL2026710 and NL2028169. These applications are herewith incorporated by reference. The devices described here may all be configured to perform the method according to the present invention.

In an embodiment, for connecting the connector, the connector handling mechanism may be configured for limiting the second moment and or force to such extend that a controlled quasi static movement of the connector is obtained.

In accordance with the present invention, a quasi static movement refers to a slow and controlled motion that is nearly stationary or moves very slowly in order to allow a system to maintain a stable position. In a quasi-static motion, driving forces are generally applied slowly and steadily enough that dynamic forces, such as acceleration and inertia, may be negligible.

When the connector is inside the socket, there is little room for motions; only design and manufacturing tolerances, and material properties give that room. Dynamic motions inside the socket are difficult to achieve, but specifically vibrations may inadvertently cause unneeded wear and tear to the vehicle, and to the socket and connector. Thereto, motions according to this application are intended to be quasi static.

Throughout this application, the term quasi static is used for those motions wherein inertial effects are negligible. When the motions would be performed without the connector being constrained by f.e. the socket, the compliance stroke resulting from inertial effects of the mass supported by the compliance would be negligible. Simplified for one direction as a mass-spring system, quasi-static behaviour is considered any motion for which:

$$m * omg \hat{} 2 / k < sqrt ( 2 ) - 1$$

### Wherein:

m=mass supported by the compliance effector
k=stiffness of the compliance assembly
omg=frequency of the motion
transfer function=1/(1+m*omg\hat{ }2/k)=1/sqrt(2) cut-off point/breakpoint of dominant behaviour in frequency response lies at −3 dB=20 log (1/sqrt(2)) This simplification holds for a device where compliance assemblies are only placed after final actuator (end-effector compliance), and where damping is omitted.

In a further embodiment the connector handling mechanism is configured for superimposing a second moment and/or force along or about a single axis. The most beneficial second moment and/or force usually depends on the specific connector-socket combination under consideration and may also depend on the exact situation under which it is used.

For example, a connector with its largest lateral (facing the plane orthogonal to the insertion direction) dimension in the vertical axis may benefit the most from a moment and a resulting controlled rotation about the lateral horizontal axis, thus leveraging the connectors dimensions to pry it in or out of the socket.

In another example, a moment or force solely in the direction of a misalignment that may have/has occurred has the added benefit of momentarily resolving the misalignment, on top of the prying motion.

In a further embodiment the connector handling mechanism is configured for at least once alternating a direction of the superimposed second moment or force, in particular in a controlled manner.

Typically, applying the additional moment or force along an axis in one direction may not be enough. Alternation along one axis, or alternation in general resulting in other patterns (f.e. a circle, or something more complex) improves the general success rate of the invention.

In yet a further embodiment the connector handling mechanism is configured for setting the second moment and/or force to an amount preferably larger than 0.03 m for translations, and/or an amount larger than 3 degree for rotations, more preferably larger than 0.01 m for translations, and/or an amount larger than 2 degree for rotations, and most preferably larger than 0.005 m for translations, and/or an amount larger than 1 degree for rotations. It has been experimentally determined that these values are beneficial for this invention

In a further embodiment the second moment and/or force are applied only if it is determined that the connector is stuck. If the second moment and/or force were applied at the wrong time, it might have an adverse effect. For example, you can only achieve a compliance stroke through actuating the positioning mechanism when the connector is inside the socket or otherwise restrained. By only engaging this method when noticing an above-nominal force for insertion or extraction, adverse effects can be avoided.

In yet a further embodiment the second moment and/or force based on input from sensors such as force sensors or a camera or a measured misalignment. Different use cases may call for different strategies. By adapting the second moment and/or force to a specific use case, the controller may choose the right strategy to resolve a specific case.

Different effects might hinder insertion or extraction. For example, a horizontal ridge in the socket might prevent an edge on the connector to pass due to a slight unintended misalignment. This could result in a slight rotation of the connector in the socket. A controlled motion of the connector within the tolerance of the socket might solve this when it moves the edge over the ridge, whereas a motion along the ridge might not help.

In yet a further embodiment, the second moment and/or force is applied in a direction where a main component of a measured misalignment is reduced. The required force to insert or extract will likely be minimal at the point of minimal misalignment. Hence, by choosing a direction that would solve a part of the measured misalignment, the controller will both minimize the insertion or extraction force by resolving the misalignment, and by the prying motion.

In more detail, the present invention refers to a device for connecting a connector of an electric vehicle charger to a socket on an electric vehicle with a supposed position and orientation, wherein:
the connector and the socket:
   each have multiple poles that are electrically mutually connectable by establishing electrically conductive pin-and-hole connection pairs, wherein the connector comprises a pin and the socket an associated hole, and/or the connector comprises a hole and the socket an associated pin, wherein:
   each pin-and-hole pair has a centre line extending axially from the centre of the pin or hole concerned, which centre lines are parallel;
are connectable by a movement directed towards each other, which movement has:
   a direction essentially parallel to the direction of the centre lines of the pins and holes, and
   a mutual orientation of the connector and socket wherein the respective centre lines of the pins and holes of at least two pin-and-hole connection pairs coincide;
each comprise a housing; where the connector and socket housings:
   are connectable by the movement directed towards each other;
   comprise mechanical guiding portions, protruding in a direction parallel to the direction of the centre lines beyond the end of the pins;
   wherein the connector and socket housings comprise manufacturing and/or operational tolerances facilitating limited motions in at least one degree of freedom;
the device comprising:
a connector handling mechanism, comprising:
   an actuated positioning mechanism, for moving the connector with at least 2 degrees of freedom with respect to a fixed world;
   at least one compliance assembly, configured to allow compliantly moving the connector in at least two degrees of freedom with respect to the fixed world,
wherein the at least one compliance assembly:
   is connected kinematically in series with the positioning mechanism, between the fixed world and the connector; and
   comprises a compliance stroke defined as the effective displacement between the actual connector position and orientation, and a neutral position and orientation of the connector defined by at least the connector handling mechanism carrying the connector with the connector being unconstrained by the socket; and
wherein, for connecting the connector, the connector handling mechanism is configured for—applying on the connector:
a first moment and/or force in the direction of the movement for moving the connector in the direction of the movement; and
at least a second moment and/or force, superimposed on the first moment and/or force, with a directional component or a direction unequal to the direction of the movement, wherein the second moment and/or force is directed towards the neutral position and orientation;
wherein the connector handling mechanism is configured to apply the at least second moment and/or force on the connector when and in particular only when the connector is at least partially inserted into the socket, wherein the second moment and/or force is applied by creating or enlarging the compliance stroke through actuation of the positioning mechanism.

In more detail, the present invention also refers to a device for disconnecting a connector of an electric vehicle charger from a socket on an electric vehicle with a supposed position and orientation, wherein:
the connector and the socket:
   each have multiple poles that are electrically mutually connectable by establishing electrically conductive pin-and-hole connection pairs, wherein the connector comprises a pin and the socket an associated hole, and/or the connector comprises a hole and the socket an associated pin, wherein:
   each pin-and-hole pair has a centre line extending axially from the centre of the pin or hole concerned, which centre lines are parallel;
are disconnectable by a movement directed from each other, which movement has:
   a direction essentially parallel to the direction of the centre lines of the pins and holes, and
   a mutual orientation of the connector and socket wherein the respective centre lines of the pins and holes of at least two pin-and-hole connection pairs coincide;
each comprise a housing; where the connector and socket housings:
   are disconnectable by the same movement directed from each other;
   comprise mechanical guiding portions, protruding in a direction parallel to the direction of the centre lines beyond the end of the pins;
wherein
   the connector and socket housings comprise manufacturing and/or operational tolerances facilitating limited motions in at least one degree of freedom;
the device comprising:
a connector handling mechanism, comprising:
   an actuated positioning mechanism, for moving a connector with at least 2 degrees of freedom with respect to a fixed world;
   at least one compliance assembly, configured to allow compliantly moving the connector in at least two degrees of freedom with respect to the fixed world,
wherein the at least one compliance assembly:
   is connected kinematically in series with the positioning mechanism, between the fixed world and the connector; and
   comprises a compliance stroke defined as the effective displacement between the actual connector position and orientation, and a neutral position and orientation of the connector defined by at least the connector handling mechanism carrying the connector with the connector being unconstrained by the socket; and
wherein, for disconnecting the connector, the connector handling mechanism is configured for applying on the connector:
a first moment and/or force in the direction of the movement for moving the connector in the direction of the movement; and
at least a second moment and/or force, superimposed on the first moment and/or force, with a directional component or a direction unequal to the direction of the movement, wherein the second moment and/or force is directed towards the neutral position and orientation;
wherein the connector handling mechanism is configured to apply the at least second moment and/or force on the connector when and in particular only when the connector is at least partially inserted into the socket, wherein the second moment and/or force is applied by creating or enlarging the compliance stroke through actuation of the positioning mechanism.

In an embodiment, for connecting or disconnecting the connector, the connector handling mechanism is configured for limiting the second moment and or force to such extend that a controlled quasi static movement of the connector is obtained.

In an embodiment, the connector handling mechanism is configured for superimposing a second moment and/or force along or about a single axis.

In an embodiment the connector handling mechanism is configured for at least once alternating a direction of the superimposed second moment or force, in particular in a controlled manner.

In an embodiment the connector handling mechanism is configured for applying the second moment and/or force by setting a compliance stroke to an amount preferably larger than 0.02 m for translations, and/or an amount larger than 2 degrees for rotations, more preferably larger than 0.01 m for translations, and/or an amount larger than 1 degrees for rotations, and most preferably larger than 0.005 m for translations, and/or an amount larger than 0.5 degree for rotations.

In an embodiment the second moment and/or force are applied only if it is determined that the connector is stuck.

In an embodiment, the invention comprises controlling the second moment and/or force based on input from sensors such as force sensors or a camera or a measured misalignment.

In an embodiment, the second moment and/or force is applied in a direction where a main component of a measured misalignment is reduced.

In an embodiment, the actuator used to apply the second moment and/or force is also used to control at least one degree of freedom of the positioning mechanism.

In an embodiment, the second movement comprises at least one of:
A linear motion along the axis with the largest dimension orthogonal to the direction of the movement,
A rotational motion about the axis orthogonal to the axis with the largest dimension and the direction of the movement; and/or
A movement around the point where a misalignment would be solved.

The invention also refers to a method for controlling an autonomous charging device (ACD) for the autonomous connection of a connector into a socket in an electric vehicle, the ACD comprising a connector handling mechanism comprising an actuated connector-positioning mechanism and a compliance assembly allowing for a compliant connection of the connector by movement in a connection direction, wherein the method comprises controlling the ACD in order to:
a) Applying, by the connector handling mechanism, a first moment and/or force on the connector in a direction substantially parallel to the connection direction;
b) Applying, by the connector handling mechanism, a second moment and/or force on the connector in a direction unequal to the direction of the first moment and/or force,
   wherein the second moment and/or force is applied
superimposed to the first moment and/or force when the connector is at least partially inserted into the EV socket, and
by creating and/or enlarging a compliance stroke of the connector.

The method according to the invention allows reducing the force necessary to connect the connector and the EV socket.

The invention also refers to a method for controlling an autonomous charging device (ACD) for the autonomous disconnection of a connector from a socket in an electric vehicle, the ACD comprising a connector handling mechanism comprising an actuated connector-positioning mechanism and a compliance assembly allowing for a compliant disconnection of the connector by movement in a disconnection direction, wherein the method comprises controlling the ACD in order to:
c) Applying, by the connector handling mechanism, a first moment and/or force on the connector in a direction substantially parallel to the disconnection direction;
d) Applying, by the connector handling mechanism, a second moment and/or force on the connector in a direction unequal to the direction of the first moment and/or force,
   wherein the second moment and/or force is applied
superimposed to the first moment and/or force when the connector is at least partially inserted into the EV socket, and
by creating and/or enlarging a compliance stroke of the connector.

The method according to the invention allows reducing the force necessary to disconnect the connector from the socket.

In an embodiment, the method comprises controlling the second moment and/or force so that a controlled quasi static movement of the connector is obtained.

In an embodiment, the method comprises applying the second moment and/or force on the connector when an interaction force between the partially inserted connector and the socket exceeds a predetermined threshold. In particular, the method allows for controlling the application of the second moment and/or force only when said interaction force exceeds a threshold in order to allow the compliance assembly to compensate for such interaction force without necessarily creating and/or enlarging a compliance stroke of the connector. The interaction force according to the present invention denotes force exerted by one object on the other object as a result of their mutual interaction. A non limiting example is a friction force, which is caused by the interaction between the surfaces of the socket and the connector when in contact.

In an embodiment, the method comprises applying the second moment and/or force on the connector in at least a direction substantially against the interaction force between the partially inserted connector and the socket.

In an embodiment, the method comprises applying the second moment and/or force on the connector when the interaction force between the partially inserted connector and the socket in the insertion/extraction direction exceeds a first predetermined threshold.

In an embodiment, the method comprises applying the second moment and/or force on the connector when the interaction force between the partially inserted connector and the socket in a direction other than the insertion/extraction direction exceeds a second predetermined threshold.

It is important to note that interaction forces may have different directions, which may affect the threshold values used to control application of the second force or moment. Therefore, in order to account for different interaction force, the method further comprises determining appropriate threshold values for different types of interaction forces, such as interaction forces in the plug-in/plug-out direction or in a direction other than the plug-in/plug-out direction.

In an embodiment, the method comprises applying the second moment and/or force until the interaction force between the partially inserted connector and the socket is determined to be below the predetermined threshold while continuing to apply the first moment and/or force on the connector in a direction substantially parallel to a plug-in direction.

In an embodiment, the method comprises applying the second moment and/or force so that at least one of the following movements of the connector is obtained:
A linear motion along the axis with the largest dimension orthogonal to the direction of the movement,
A rotational motion about the axis orthogonal to the axis with the largest dimension and the direction of the movement;
A movement around the point where a misalignment would be solved;
A quasi-static square diamond motion;
A sine wave motion;

In an embodiment, the method comprises alternating between motions when applying the second moment and/or force is determined not to lower the interaction force between the partially inserted connector and the socket.

In an embodiment, the method comprises applying the first and/or second moment and/or force until an electric connection between the socket and the connector is determined.

In an embodiment, the method comprises receiving a signal that the connector and socket are clamped before applying the second moment and/or force. The invention will be elucidated into more detail with reference to the following figures, wherein:

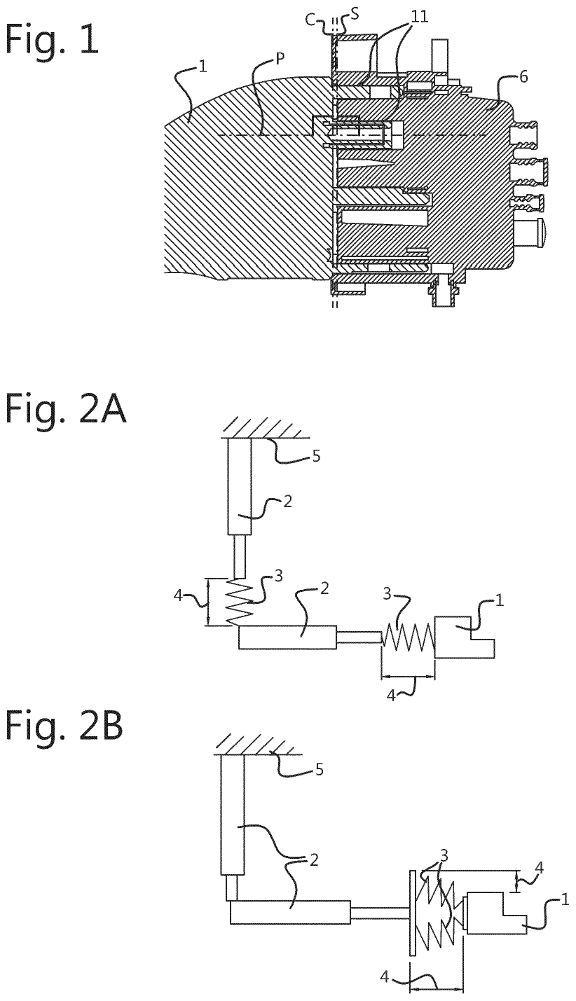

FIG. 1 shows a connector (1) normally inserted in a socket (6), with the direction of insertion (P), a vertical axis (C) fixed to the connector, a vertical axis(S) fixed to the socket, and slight tolerances (11) present when the connector is normally inserted. Usually, the electrical contacts (not shown in the figure) facilitate a symmetrical (or at least constant) use of the tolerances, by means of the (passive) mechanism to provide sufficient contact pressure between the conductors (for example a leaf-spring type of mechanism for one side of the pin-hole pair).

FIGS. 2a and 2b illustrate two implementations of a connector handling mechanism. It shows a connector (1) positioned by a positioning mechanism comprised of actuators (2), with compliance assemblies (3) kinematically in series with the actuators (2) between the fixed world (5) and the connector (1), where the compliance assemblies are distributed throughout the mechanism in FIG. 2a, or concentrated near the connector (1) in FIG. 2b. The figures also show the position and orientation of the connector (1) and the compliance position (4) of the compliance assemblies (3) when it is unconstrained by a socket, i.e. the neutral position and orientation of the connector (1).

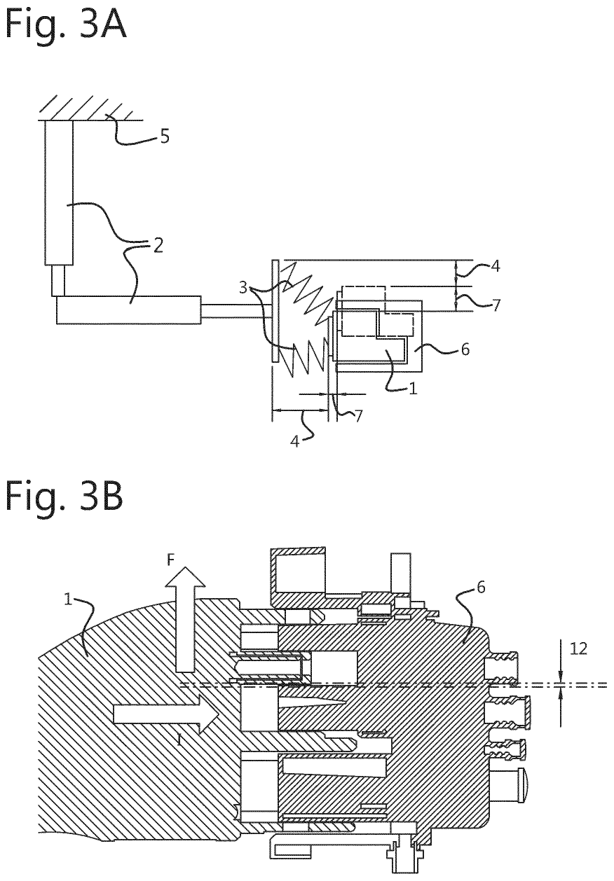

FIGS. 3a and 3b illustrate the result of applying the invention within the connector handling mechanism (FIG. 3a) through a translation orthogonal to the direction of insertion, and the result zoomed in on the connector-socket interaction (FIG. 3b).

FIG. 3a shows a connector handling mechanism with a compliance stroke (7) relative to the normal compliance position (4) of the compliance assemblies (3) when the connector (1) would be unconstrained by the socket (6), i.e. the neutral position and orientation of the connector (1).

FIG. 3b shows the connector (1) partially inserted into the socket (6). It also shows a force (F) and force (I) applied by the compliance assemblies (3) on the connector (1), resulting from the compliance stroke (7) (illustrated in FIG. 3a), where the force in direction of insertion (I) aims to provide an inserting motion, and the force orthogonal to the direction of insertion (F) aims to reduce the requirements for (I). The force orthogonal to the direction of insertion (F) results in a slight displacement (12) of the connector (1) within the tolerances of the socket (6) with respect to symmetrical use of the tolerances (11). It effectively shows one instance during a prying motion.

While FIGS. 3a and 3b illustrate the effect for insertion, the same effect can be achieved for extraction by using a compliance stroke that would result in a force in the opposite direction of I.

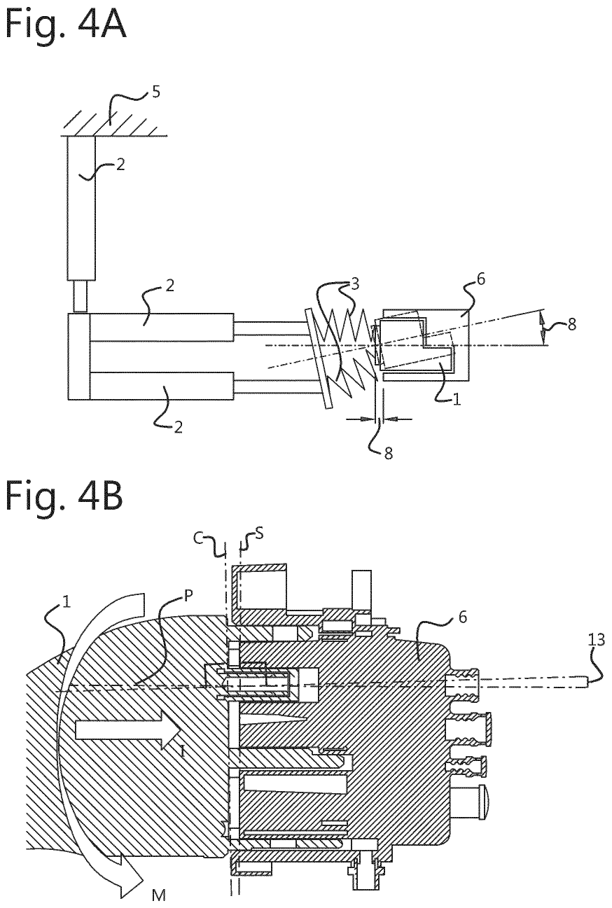

FIGS. 4a and 4b illustrate the result of applying the invention within the connector handling mechanism (FIG. 4a) through a rotation about an axis orthogonal to the direction of insertion, and the result zoomed in on the connector-socket interaction (FIG. 4b).

FIG. 4a shows a connector handling mechanism with a compliance stroke (8) of the compliance assemblies (3) when the connector (1) would not be constrained by the socket (6).

FIG. 4b shows the connector (1) partially inserted into the socket (6). It also shows a moment (M) and force (I) applied by the compliance assemblies (3) on the connector (1), resulting from the compliance stroke (8), where the force in direction of insertion (I) aims to provide an inserting motion, and the moment (M) about an axis orthogonal to the direction of insertion aims to reduce the requirements for (I). The moment about an axis orthogonal to the direction of insertion (M) results in a slight rotation (13) of the connector (1) within the tolerances of the socket (6) with respect to the direction of insertion (P). It effectively shows one instance during a prying motion. While FIGS. 4a and 4b illustrate the effect for insertion, the same effect can be achieved for extraction by using a compliance stroke that would result in a force in the opposite direction of I.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. Device for connecting a connector of an electric vehicle charger to a socket on an electric vehicle with a supposed position and orientation, wherein:
the connector and the socket:
each have multiple poles that are electrically mutually connectable by establishing electrically conductive pin-and-hole connection pairs, wherein the connector comprises a pin and the socket an associated hole, and/or the connector comprises a hole and the socket an associated pin, wherein:
each pin-and-hole pair has a centre line extending axially from the centre of the pin or hole concerned, which centre lines are parallel;
are connectable by a movement directed towards each other, which movement has:
a direction essentially parallel to the direction of the centre lines of the pins and holes, and
a mutual orientation of the connector and socket wherein the respective centre lines of the pins and holes of at least two pin-and-hole connection pairs coincide;
each comprise a housing; where the connector and socket housings:
are connectable by the movement directed towards each other;
comprise mechanical guiding portions, protruding in a direction parallel to the direction of the centre lines beyond the end of the pins;
wherein the connector and socket housings comprise manufacturing and/or operational tolerances facilitating limited motions in at least one degree of freedom;
the device comprising:
a connector handling mechanism, comprising:
an actuated positioning mechanism, for moving the connector with at least 2 degrees of freedom with respect to a fixed world;
at least one compliance assembly, configured to allow compliantly moving the connector in at least two degrees of freedom with respect to the fixed world,
wherein the at least one compliance assembly:
is connected kinematically in series with the positioning mechanism, between the fixed world and the connector; and
comprises a compliance stroke defined as the effective displacement between the actual connector position and orientation, and a neutral position and orientation of the connector defined by at least the connector handling mechanism carrying the connector with the connector being unconstrained by the socket; and
wherein, for connecting the connector, the connector handling mechanism is configured for—applying on the connector:
a first moment and/or force in the direction of the movement for moving the connector in the direction of the movement; and
at least a second moment and/or force, superimposed on the first moment and/or force, with a directional component or a direction unequal to the direction of the movement, wherein the second moment and/or force is directed towards the neutral position and orientation;
characterized in that
the connector handling mechanism is configured to apply the at least second moment and/or force on the connector when the connector is at least partially inserted into the socket, wherein the second moment and/or force is applied by creating or enlarging the compliance stroke through actuation of the positioning mechanism.

2. Device for disconnecting a connector of an electric vehicle charger from a socket on an electric vehicle with a supposed position and orientation, wherein:
the connector and the socket:
each have multiple poles that are electrically mutually connectable by establishing electrically conductive pin-and-hole connection pairs, wherein the connector comprises a pin and the socket an associated hole, and/or the connector comprises a hole and the socket an associated pin, wherein:
each pin-and-hole pair has a centre line extending axially from the centre of the pin or hole concerned, which centre lines are parallel;
are disconnectable by a movement directed from each other, which movement has:
a direction essentially parallel to the direction of the centre lines of the pins and holes, and
a mutual orientation of the connector and socket wherein the respective centre lines of the pins and holes of at least two pin-and-hole connection pairs coincide;
each comprise a housing; where the connector and socket housings:
are disconnectable by the same movement directed from each other;
comprise mechanical guiding portions, protruding in a direction parallel to the direction of the centre lines beyond the end of the pins;
wherein
the connector and socket housings comprise manufacturing and/or operational tolerances facilitating limited motions in at least one degree of freedom;
the device comprising:
a connector handling mechanism, comprising:
an actuated positioning mechanism, for moving a connector with at least 2 degrees of freedom with respect to a fixed world;
at least one compliance assembly, configured to allow compliantly moving the connector in at least two degrees of freedom with respect to the fixed world,
wherein the at least one compliance assembly:
is connected kinematically in series with the positioning mechanism, between the fixed world and the connector; and
comprises a compliance stroke defined as the effective displacement between the actual connector position and orientation, and a neutral position and orientation of the connector defined by at least the connector handling mechanism carrying the connector with the connector being unconstrained by the socket; and
wherein, for disconnecting the connector, the connector handling mechanism is configured for applying on the connector:
a first moment and/or force in the direction of the movement for moving the connector in the direction of the movement; and
at least a second moment and/or force, superimposed on the first moment and/or force, with a directional component or a direction unequal to the direction of the movement, wherein the second moment and/or force is directed towards the neutral position and orientation;
wherein,
the connector handling mechanism is configured to apply the at least second moment and/or force on the connector when the connector is at least partially inserted into the socket, wherein the second moment and/or force is applied by creating or enlarging the compliance stroke through actuation of the positioning mechanism.

3. Device according to claim 1, wherein, for connecting or disconnecting the connector, the connector handling mechanism is configured for limiting the second moment and or force to such extend that a controlled quasi static movement of the connector is obtained.

4. Device according to claim 1, wherein the connector handling mechanism is configured for superimposing a second moment and/or force along or about a single axis.

5. Device according to claim 1, wherein the connector handling mechanism is configured for at least once alternating a direction of the superimposed second moment or force in a controlled manner.

6. Device according to claim 1, wherein the connector handling mechanism is configured for applying the second moment and/or force by setting a compliance stroke to an amount larger than 0.005 m for translations, and/or an amount larger than 0.5 degree for rotations.

7. Device according to claim 1, wherein the second moment and/or force are applied only if it is determined that the connector is stuck.

8. Device according to claim 1, comprising controlling the second moment and/or force based on input from sensors such as force sensors or a camera or a measured misalignment.

9. Device according to claim 1, wherein the second moment and/or force is applied in a direction where a main component of a measured misalignment is reduced.

10. Device according to claim 1, wherein an actuator used to apply the second moment and/or force is also used to control at least one degree of freedom of the positioning mechanism.

11. Device according to claim 1, wherein the second movement comprises at least one of:
a. A linear motion along the axis with the largest dimension orthogonal to the direction of the movement,
b. A rotational motion about the axis orthogonal to the axis with the largest dimension and the direction of the movement; and/or
c. A movement around the point where a misalignment would be solved.

12. A method for controlling an autonomous charging device (ACD) for the autonomous connection of a connector into a socket in an electric vehicle, the ACD comprising a connector handling mechanism comprising an actuated connector-positioning mechanism and a compliance assembly allowing for a compliant connection of the connector by movement in a connection direction, the method comprising:
a. applying, by the connector handling mechanism, a first moment and/or force on the connector in a direction substantially parallel to the connection direction;
b. applying, by the connector handling mechanism, a second moment and/or force on the connector in a direction unequal to the direction of the first moment and/or force, wherein the second moment and/or force is applied
“superimposed to the first moment and/or force when the connector is at least partially inserted into the EV socket, and”
by creating and/or enlarging a compliance stroke of the connector.

13. A method for controlling an autonomous charging device (ACD) for the autonomous disconnection of a connector from a socket in an electric vehicle, the ACD comprising a connector handling mechanism comprising an actuated connector-positioning mechanism and a compliance assembly allowing for a compliant disconnection of the connector by movement in a disconnection direction, the method comprising:
c. applying, by the connector handling mechanism, a first moment and/or force on the connector in a direction substantially parallel to the disconnection direction;
d. applying, by the connector handling mechanism, a second moment and/or force on the connector in a direction unequal to the direction of the first moment and/or force, wherein the second moment and/or force is applied
“superimposed to the first moment and/or force when the connector is at least partially inserted into the EV socket, and”
by creating and/or enlarging a compliance stroke of the connector.

14. Method according to claim 12 further comprising controlling the second moment and/or force so that a controlled quasi static movement of the connector is obtained.

15. Method according to claim 12 further comprising applying the second moment and/or force on the connector when an interaction force between the partially inserted connector and the socket exceeds a predetermined threshold.

16. Method according to claim 15 further comprising applying the second moment and/or force on the connector in at least a direction substantially against the interaction force between the partially inserted connector and the socket.

17. Method according to claim 15 further comprising applying the second moment and/or force on the connector when an interaction force between the partially inserted connector and the socket in the insertion/extraction direction exceeds a first predetermined threshold.

18. Method according to claim 15 further comprising applying the second moment and/or force on the connector when an interaction force between the partially inserted connector and the socket in a direction other than the insertion/extraction direction exceeds a second predetermined threshold.

19. Method according to claim 15 further comprising applying the second moment and/or force until the interaction force between the partially inserted connector and the socket is determined to be below the predetermined threshold while continuing to apply the first moment and/or force on the connector in a direction substantially parallel to a plug-in direction.

20. Method according to claim 12 further comprising applying the second moment and/or force so that at least one of the following movements of the connector is obtained:
a. a linear motion along the axis with a largest dimension orthogonal to the direction of the movement,
b. a rotational motion about the axis orthogonal to the axis with the largest dimension and the direction of the movement;
c. a movement around the point where a misalignment would be solved;
d. a quasi-static square diamond motion;
e. a sine wave motion;

21. Method according to claim 12 further comprising alternating between motions when applying the second moment and/or force is determined not to lower the interaction force between the partially inserted connector and the socket.

22. Method according to claim 12 further comprising applying the first moment and/or force and/or the second moment and/or force until an electric connection between the socket and the connector is determined.

23. Method according to claim 12 further comprising receiving a signal that the connector and socket are clamped before applying the second moment and/or force.
